(19) United States
(12) Patent Application Publication
(10) Pub. No.: US 2007/0108646 A1
(43) Pub. Date: May 17, 2007

(54) Method of fabricating a composite structure with details

(76) Inventors: Michael J. Louderback, Mission Viejo, CA (US); Gary A. Tremblay, San Diego, CA (US); John Bosher, Oceanside, CA (US)

Correspondence Address: STETINA BRUNDA GARRED & BRUCKER, 75 ENTERPRISE, SUITE 250, ALISO VIEJO, CA, 92656, US

(21) Appl. No.: 11/273,901

(22) Filed: Nov. 15, 2005

(51) Int. Cl. B27N 3/10

(52) U.S. Cl. 264/40.5; 264/257

(57) ABSTRACT

A method of fabricating a composite part with integral structural details is provided. Fibrous material may be wrapped on a detail surface and an interface surface of a first detail mold. Fibrous material may also be wrapped on a detail surface and an interface surface of a second detail mold. Fibrous material may also be laid on a molding surface of a tool mold to form a control surface of the part. The first and second detail molds may be arranged on the molding surface of the tool mold to form the details. In particular, fibrous material wrapped on the detail surfaces of the first and second detail molds may be disposed adjacent to each other, and fibrous material wrapped on the interface surfaces of the first and second detail molds may be disposed adjacent to the fibrous material laid on the molding surface. Resin is flowed into the detail molds via inlet ports and through integral resin channels into the fibrous material. The resin flowed through the fibrous material laid on the tool mold and the fibrous material wrapped on the detail molds are co-cured to unitize the stiffeners and the details integrally formed with the part.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates to a method of fabricating a composite part having integral structural details.

Fiber composite parts may be generally formed into a wide variety of shapes. For example, composite fibers may be shaped as a fairing. However, due to fiber composite parts being generally more flexible in bending and less stiff compared to steel or aluminum, the solid laminate fairing fabricated of composite fibers may not be capable of withstanding high wind gusts thereby deforming the fiber composite fairing while the airplane is in motion. Wind gusts may buckle and stress the fiber composite fairing thereby ultimately possibly destroying the fiber composite fairing. As such, solid laminate fiber composite parts may have limited applicability to highly stressed conditions where the structure is subjected to bending loads.

Stiffeners may be incorporated into the fiber composite fairing to increase the stiffness of the fairing for withstanding the air gust and air pressures applied to the fairing as the airplane flies through the air. However, manufacturers of fiber composite parts have been unsuccessful in incorporating stiffeners into fairings in a cost efficient manner. Moreover, manufacturers of fiber composite parts have been unsuccessful in reliably incorporating stiffeners into an airplane fairing in a unitized fashion. One reason is that the resin may not flow through the fiber completely prior to resin cure thereby leaving dry areas of fiber. Another reason is that pooling of resin may occur as resin flows through the fiber. The state of the art requires that the stiffeners be fabricated separately and subsequently joined or assembled to the parent molded surface.

Accordingly, there is a need in the art for an improved method of fabricating a fiber composite part which incorporates structural details in a single unitized structure.

### BRIEF SUMMARY

The present invention addresses the needs discussed above and discussed herein as well as those that are known in the art. As will be discussed in detail below, a method of fabricating a part with integral structural details will be discussed in relation to a fairing with stiffeners. However, the example (i.e., fairing with stiffeners) used to describe the method is not meant to limit the scope of this disclosure. Accordingly, it is contemplated that the description of the method may be variously embodied and employed to other types of parts such as trusses with integral structural details.

A fairing may define a control surface. The control surface may have a smooth curved configuration bounded by an upper horizontal edge, opposed curvilinear lateral edges, and a lower arc shaped interface which mates with an adjacent part of an assembly. On a rear side of the fairing, a plurality of horizontal and vertical stiffeners may be formed behind the control surface to stiffen the control surface.

The control surface may be formed by laying fiber on a molding surface of a tool mold. The molding surface may have a corresponding negative configuration of the control surface of the fairing. The tool mold may also have other surfaces for defining the upper horizontal edge, lateral opposed edges and the lower arc shaped interface.

The stiffeners may be fabricated by wrapping a plurality of detail molds, assembling the wrapped detail molds onto the molding surface, flowing resin through the fiber and curing the fiber. In particular, an interface surface and a detail surface of the detail mold may be wrapped with fiber. A top surface of the detail mold may be absent fiber such that the detail mold may be removed from the assembly after the resin has flowed through the fiber and the composite part is cured. The detail molds may be collectively assembled onto the tool mold in a jig saw configuration. Fibers laid on detail surfaces of adjacent detail molds may collectively form the stiffeners along the adjacent boundaries.

The fibers laid on the detail mold may be engaged to the detail mold via vacuum bagging. A plurality of detail molds wrapped with fiber may be inserted into a first vacuum bag. A continuous cloth material may be laid over each of the detail molds, and more particularly, the fiber wrapped about the detail molds. The cloth may also extend continuously to an output port of the first vacuum bag. The first vacuum bag may be sealed and a vacuum applied to the vacuum port. Air may be evacuated out of the first vacuum bag, and the first vacuum bag may apply pressure uniformly onto the fiber so as to compress the fiber onto the detail mold. After sufficient time has elapsed, the detail molds are removed from the first vacuum bag and assembled on the tool mold in the jig saw configuration.

The detail molds and the tool mold may be enclosed in a second vacuum bag. The second vacuum bag may have a plurality of resin input ports and at least one resin output port to flow resin through the fiber wrapped about the detail molds and fiber laid on the tool mold.

The second vacuum bag may be connected to a manifold and a resin reservoir via the resin input port. Also, the second vacuum bag may be connected to a vacuum pump via the resin output port. To flow resin through the fiber, the vacuum pump may be activated thereby evacuating the air from the vacuum bag. Resin may be drawn from the resin reservoir to the manifold. The manifold distributes the resin to the resin input ports of the second vacuum bag. Resin flows through the fibers wrapped on the detail molds and fibers laid on the tool mold. The resin is evacuated from the second vacuum bag via the resin output port(s) of the second vacuum bag. The resin drawn from the second vacuum bag may be collected in resin reservoirs. Since the resin is drawn into the second vacuum bag through the plurality of resin input ports, the resin flows uniformly throughout the fibers wrapped about the detail molds and the fibers laid on the tool mold. The reason is that flow of resin through the fiber is managed in smaller controllable portions.

The resin also flows uniformly through each of the detail molds via a system of resin input and resin channels formed integrally with each of the detail molds. The resin input may be formed at a central location of a top surface of the detail mold. The resin input may be a circular aperture which extends through the detail mold from the top surface to a bottom surface of the detail mold. The resin input may be in fluid communication with a plurality of resin channels integrally formed on the bottom surface of the detail mold. The plurality of resin channels may have a star burst configuration to promote a uniform flow front of resin toward the fibers laid on the interface surface of the detail mold. When resin flows through the second vacuum bag, resin flows through the resin input and through the resin channels. When the resin reaches the distal end of the resin channel, a back pressure is created to force or promote the resin flow front to reach the fiber uniformly. The resin flow front reaches the inner periphery of the fiber laid on the interface surface uniformly thereby promoting a resin flow through all of the fiber.

In another aspect of the method, a manifold may be placed on top of the assembled detail molds. A bottom surface of the manifold may have a mating configuration with the aggregate of top surfaces of the detail molds. The manifold bottom surface may have a system of resin channels that connect a resin input of the manifold to the resin inputs of the detail molds. When the manifold is laid on the top surfaces of the detail molds, a resin conduit is formed. The detail molds, tool mold and the manifold may be inserted into a second vacuum bag with a manifold resin input alignable to a resin input port of the second vacuum bag. Resin may be flowed through the resin input port through the manifold resin input which distributes the resin to the plurality of resin inputs of the plurality of detail molds. The second vacuum bag may also have an output port for drawing excess resin out of the second vacuum bag.

In another aspect of the method, a manufacturing output rate of a composite fiber part manufacturer may be increased with the method disclosed herein. The reason is that the method divides the labor required to build or fabricate the part into a plurality of more separate and manageable parts. For example, a first employee may wrap fiber about a first detail mold, a second employee may wrap fiber about a second detail mold, and a third employee may lay fiber on the tool mold.

The method discussed herein for fabricating the part with the detail has the following advantages. First, resin is distributed to a plurality of input ports and detail molds. This provides control of resin flow on smaller more manageable areas increasing the likelihood that the fiber is flowed with resin and pooling is less likely. This distributed flow of resin also reduces the rate of exotherm associated with the overall volume of resin, to allow for a longer infusion time prior to gelling of the resin and also enabling larger parts to be fabricated The method discussed herein may be referred to as affordable feature integration. Affordable feature integration facilitates parallel production flow resulting in faster throughput, reduced turn around times and reduced costs. Additionally, the manifold which distributes the resin into the plurality of resin input of the detail molds is configurable to fit any configuration of resin inputs. The detail molds may also be located on the tool mold using a third plate located by an external datum. Furthermore, this location of the detail molds provides precise positioning of the details thereby establishing control of the external surfaces of the part and “detolerancing” the internal location of the fiber layers.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a front view of a fairing fabricated via a method of wrapping fibrous material about a plurality of detail molds, laying fibrous material on a molding surface of a tool mold, assembling the detail molds and tool mold in a jig saw configuration, flowing resin through the fibrous material, and curing the resin;

FIG. 2 is a rear view of the fairing shown in FIG. 1;

FIG. 3 is a first truss structure fabricated with the steps used to fabricate the fairing shown in FIGS. 1 and 2;

FIG. 4 is a second truss structure fabricated with the steps used to fabricate the fairing shown in FIGS. 1 and 2;

FIG. 5 is a perspective view of a tool mold with a portion thereof laid with fibrous material and a portion thereof not laid with fibrous material;

FIG. 6 is a flow chart of the method of fabricating a part with a detail;

FIG. 7 is a plurality of detail molds assembled on top of a molding surface of the tool mold;

FIG. 7A is a cross-sectional view of a stiffener shown in FIG. 6;

FIG. 8 is a bottom view of a detail mold illustrating fibrous material wrapped about an interface surface and a detail surface, and resin channels in a star burst configuration leading from a resin input, and dash lines showing a progression of a resin flow front;

FIG. 9 is a top view of the detail mold shown in FIG. 7 illustrating a resin input at a central portion thereof;

FIG. 10 is a plurality of detail molds wrapped with fibrous material and inserted into a first vacuum bag for compressing the fibrous material onto the detail mold;

FIG. 11 is a system view of a resin distribution system, the resin distribution system has a resin reservoir filled with resin in fluid communication with a manifold which distributes the resin to a plurality of input ports of a second vacuum bag, the resin flows through the fibrous material laid on the detail molds and the tool mold and excess resin is evacuated from the second vacuum bag into resin reservoirs;

FIG. 12 is a top view of a manifold with a plurality of resin channels which distributes resin to the plurality of resin inputs of the detail molds; and

FIG. 13 is a cross-sectional view of the manifold and detail molds shown in FIG. 12.

### DETAILED DESCRIPTION

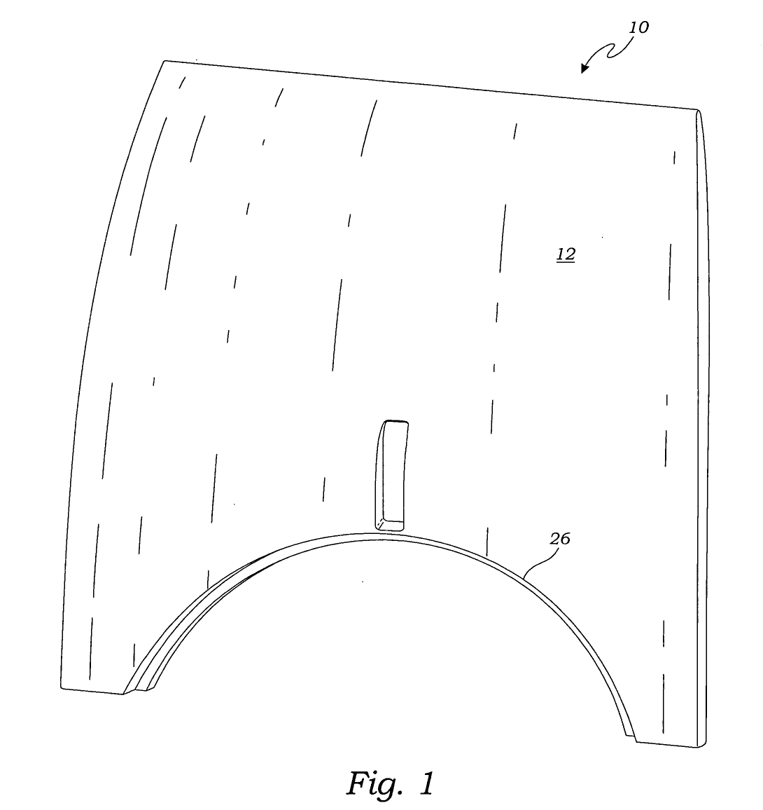

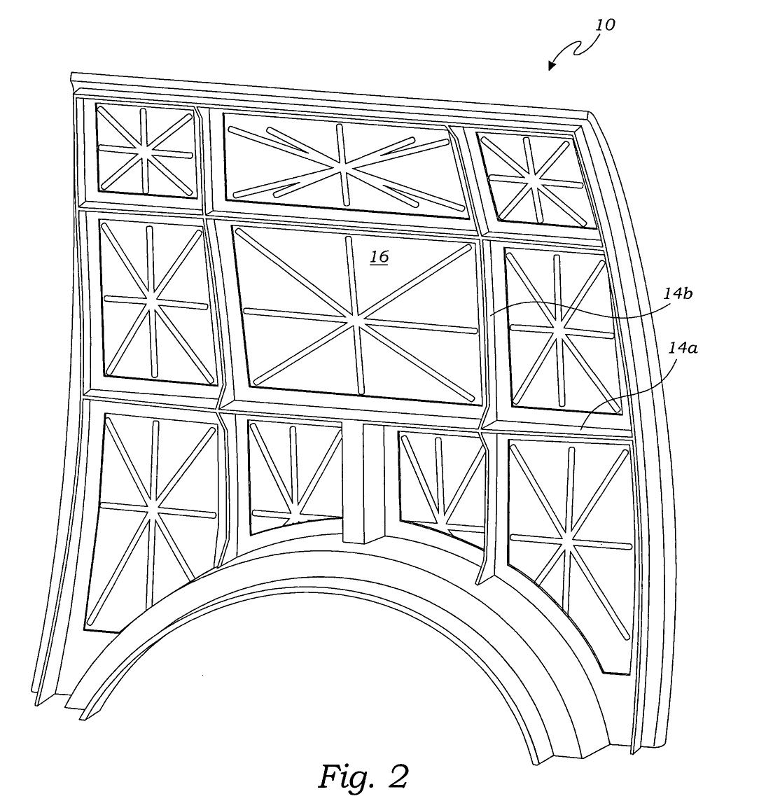

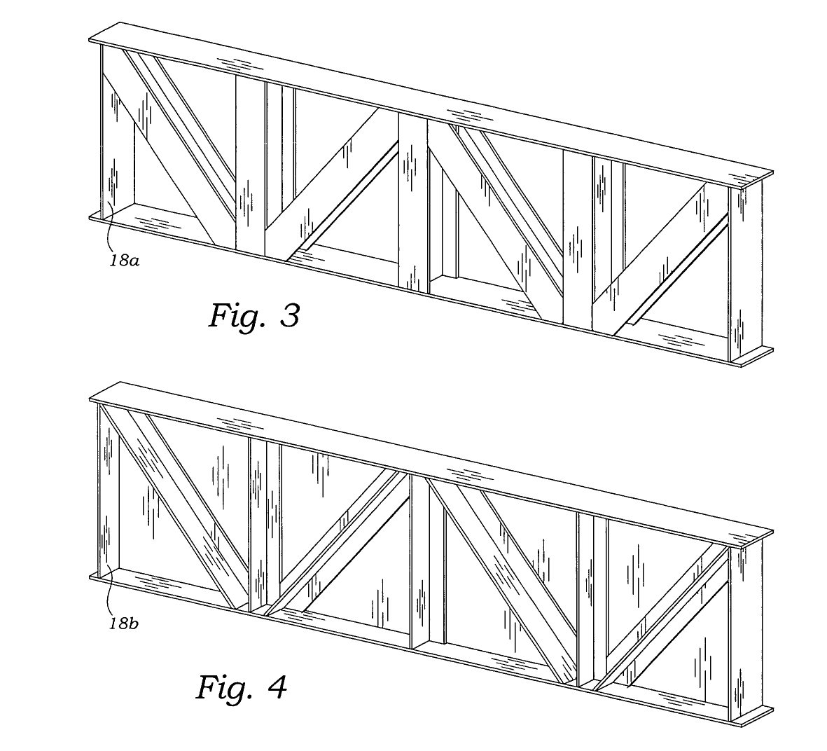

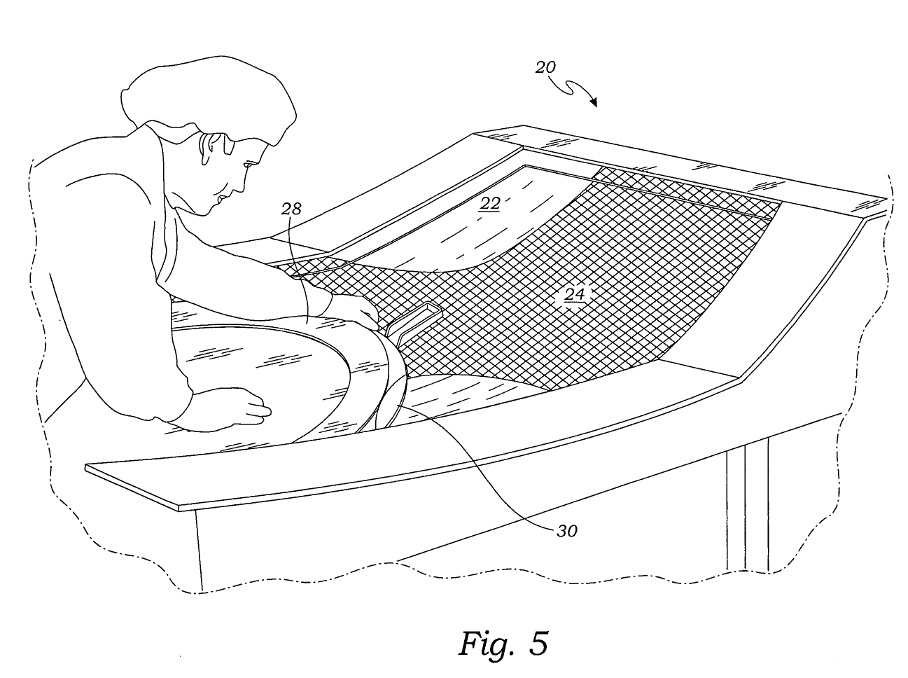

Referring now to FIGS. 1 and 2, front and rear views of a fairing 10 fabricated with the method of the present invention are shown. FIG. 1 illustrates the control surface 12 of the fairing 10, and FIG. 2 illustrates a plurality of stiffeners 14a, b on a back side 16 of the fairing 10. The stiffeners 14 provide stiffness to the control surface 12 of the part 10. It is also contemplated that the method of the present invention may be employed and embodied to fabricate parts other than a fairing 10. By way of example and not limitation, the method of fabricating a part may be employed and embodied to fabricate truss structures 18a, b, as shown in FIGS. 3 and 4. Accordingly, the drawings and the descriptive portion of this disclosure is not meant to limit the scope of the present invention but is merely provided as an example of various embodiments and aspects of the present invention.

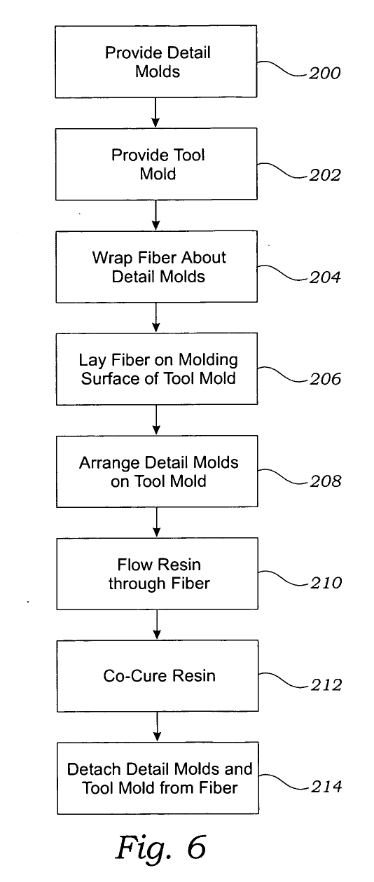

Referring now to FIG. 5, a tool mold 20 of the fairing 10 is shown. A molding surface 22 of the tool mold 20 may have a smooth exterior surface. More particularly, the molding surface 22 of the tool mold 20 may have a negative configuration of the control surface 12. The molding surface 22 of the tool mold 20 may have a different configuration based on the function of the part to be fabricated.

Fibrous material 24 may be laid on the molding surface 22 of the tool mold 20. The fibrous material 24 may be provided in a sheet form and cut to size to fit the molding surface 22 of the tool mold 20. Additionally, a curved lower portion 26 (see FIG. 1) of the fairing 10 may be fabricated by laying an arc shaped fibrous material layer 28 on a corresponding bridge 30 formed on the tool mold 20. The entire molding surface 22 of the tool mold 20 may be laid with one or more fibrous material layers 24 depending on the specific application of the part to be fabricated. The fibrous material 24 laid on the tool mold molding surface 22 defines the control surface 12 of the fairing 10 and the back surface 16 of the fairing 10 as well. Stiffeners 14, and more generically, details may be fabricated on the back surface 16 of the fairing 10 to increase the stiffness of the fairing 10. These stiffeners 14 may be co-cured with the fairing 10/control surface 12. The stiffeners 14 represent one embodiment of the detail that may be fabricated on the part. It is also contemplated that other types of details may be fabricated with the part having various configurations and functions.

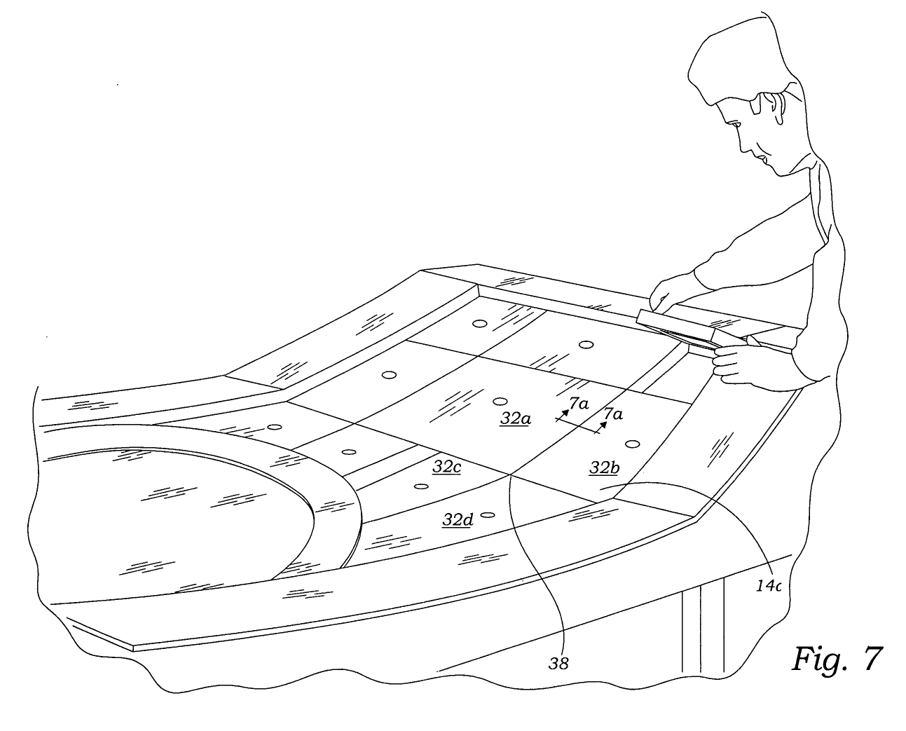

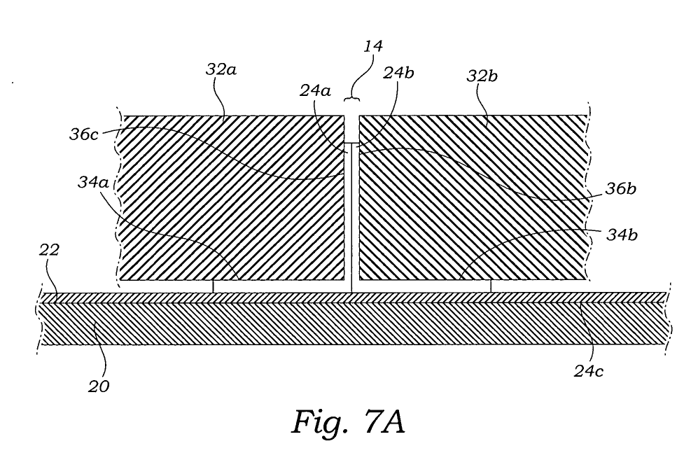

Referring to FIG. 6, the stiffeners 14 are fabricated with the control surface 12 by providing a plurality of detail molds 200, providing a tool mold 202, wrapping fibrous material 204 about the detail molds, laying fibrous material 206 on the molding surface of the tool mold, arranging 208 the detail molds on the tool mold so as to collectively form the details, flowing resin 210 through the fibrous material, co-curing 212 the resin and detaching 214 the detail molds and tool mold from the fibrous material. For example, a first detail mold 32a (see FIGS. 7 and 7A) and a second detail mold 32b (see FIGS. 7 and 7A) disposed adjacent to each other may define one of the stiffeners 14 (see FIG. 7A). As shown in FIG. 7A, the first detail mold 32a may have fibrous material 24a wrapped about an interface surface 34a and a detail surface 36a. The fibrous material wrapped on the detail mold 32A may have a reversed L-shaped configuration. Likewise, the second detail mold 32b may have fibrous material 24b wrapped about the detail surface 36b and the interface surface 34b with an L-shaped configuration. The fibrous materials 24a, b wrapped on the interface surfaces 34a, b may be disposed adjacent to the molding surface 22 of the tool mold 20. The fibrous materials 24a wrapped on the detail surface 36a of the detail mold 32a may be disposed adjacent to fibrous material 24b wrapped on the detail surface 36b of adjacent detail mold 36b. Resin may be flowed through the fibrous material 24a, b wrapped about the first and second detail molds 32a, b as well as the fibrous material 24c laid on the molding surface 22 of the tool mold 20 and co-cured. When the resin is cured, a strong bond is formed between the fibrous materials 24a, b wrapped on the first and second detail molds 32a, b and the fibrous materials 24c laid on the molding surface 22.

In another example, as shown in FIG. 7, the first detail mold 32a, the second detail mold 32b, a third detail mold 32c and fourth detail mold 32d may be disposed adjacent to each other with a corner of each mold 32a-d at a common point to collectively define an intersection 38 of the horizontal stiffener 14a and the vertical stiffener 14b. The interface surface 34 and the detail surface 36 of each of the detail molds 32a-d may be wrapped with fibrous material 24 thereabout. The interface surface 34 may be disposed adjacent to the molding surface 22 of the tool mold 20, whereas, the detail surface 36 may be disposed adjacent to detail surfaces 36 of adjacent detail molds 32. The fibrous materials 24 wrapped on the detail molds 32 and the fibrous materials 24 laid on the molding surface 22 of the tool mold 20 collectively have a configuration of the details.

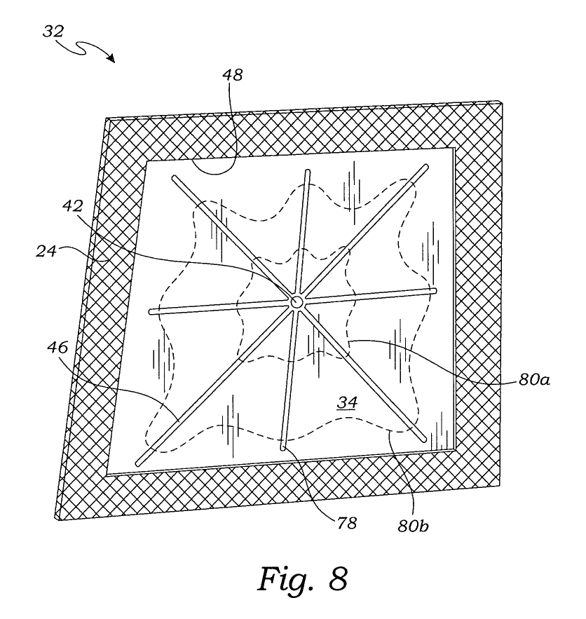

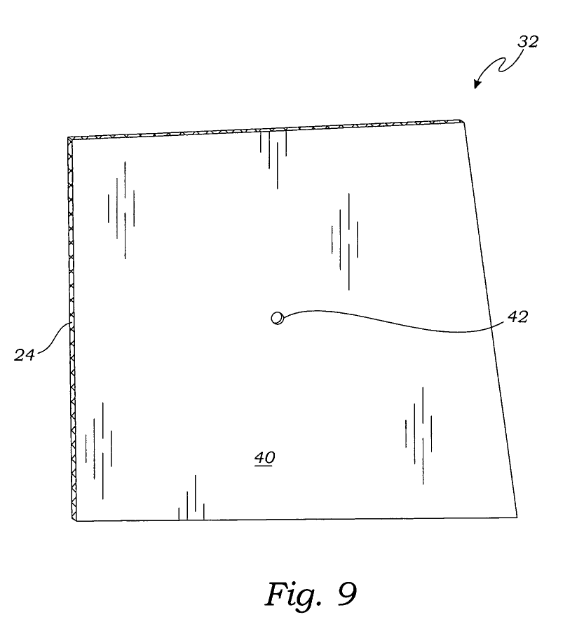

FIGS. 8 and 9 are a bottom view and a top view, respectively, of the detail mold 32 wrapped with fibrous material 24. More particularly, FIG. 9 illustrates a top view of the detail mold 32. A center of the top surface 40 may be formed with an aperture or resin input 42 that extends through to the interface surface or bottom surface 34 of the detail mold 32, as shown in FIGS. 8 and 9. As shown, the resin input 42 extends through the entire thickness of the detail mold 32. Moreover, a plurality of resin channels 46 are formed with a star burst configuration. (See FIG. 8). The resin channels 46 extend toward but do not extend to the inner perimeter 48 of the fibrous material 24 laid on the interface surface 34 of the detail mold 32. The fibrous material 24 may be wrapped on the interface surface 34 as well as the detail surface 36. As shown in FIG. 8, the fibrous material 24 may be wrapped about the entire periphery of the detail mold 32 on the interface surface 34 as well as the detail surface 36.

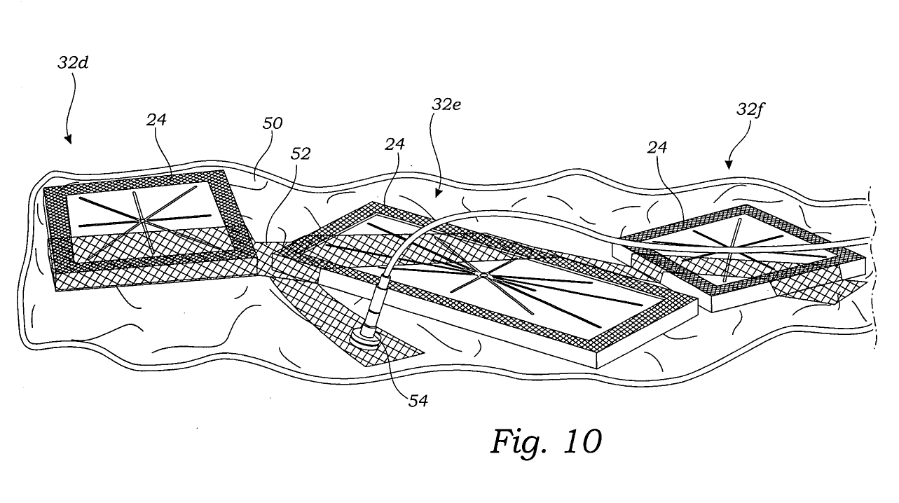

Referring now to FIG. 10, the plurality of detail molds 32d-f wrapped with fibrous material 24 may be inserted into a first vacuum bag 50 with a continuous cloth member 52 extending from a vacuum port 54 of the first vacuum bag 50 to each of the detail molds 32d-f. The first vacuum bag 50 may be hermetically sealed and a vacuum applied to the vacuum port 54 to evacuate the air from the first vacuum bag 50. Upon evacuation, the first vacuum bag 50 applies uniform pressure on the fibrous material 24 to compress the fibrous material 24 onto the interface surface 34 and the detail surface 36 of the detail molds 32d-f. After sufficient time has elapsed for the fibrous material 24 to engage the detail molds 32d-f, the detail molds 32d-f may be collectively arranged in a jig-saw style manner on the molding surface 22 of the tool mold 20, as shown in FIG. 7.

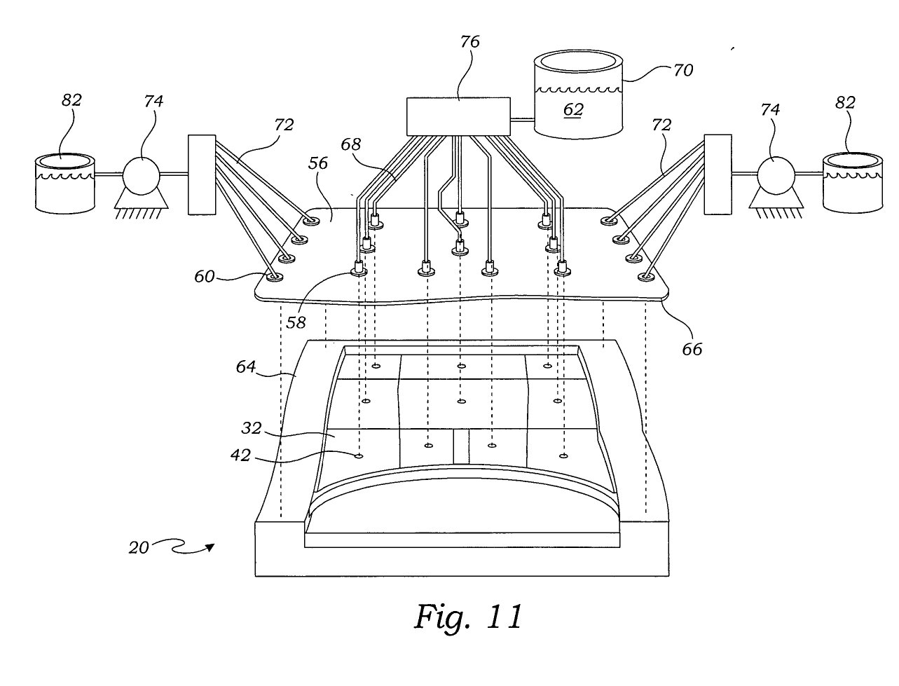

Resin may be flowed through the fibrous material 24 wrapped on the detail mold 32 and laid on the tool mold 20 and co-cured together to form the fairing 10 with stiffeners 14. In particular, the tool mold 20 and the detail molds 32 may be placed or inserted into a second vacuum bag 56, as shown in FIG. 11. The second vacuum bag 56 may have a plurality of resin input ports 58 that are alignable to the resin inputs 42 of the detail molds 32, as shown in FIG. 11. The second vacuum bag 56 may also have a plurality of output ports 60 for applying a vacuum to draw resin 62 through the resin input ports 58 to the output ports 60. When the resin 62 is flowed from the resin input port 58 to the resin output port 60, resin 62 flows through the fibrous material 24 laid on the tool mold 20 as well as the fibrous material 24 wrapped on the detail molds 32.

More particularly, the second vacuum bag 56 may be laid on an outer periphery 64 of the tool mold 20, as shown in FIG. 11. A periphery 66 of the second vacuum bag 56 shown in FIG. 11 may be hermetically sealed to the periphery 64 of the tool mold 20 thereby forming a vacuum-tight cavity wherein the fibrous materials 24 laid on the tool mold 20 and the detail mold 32 are trapped therein. In the alternative, the second vacuum bag 56 may entirely enclose the tool mold 20 and the plurality of detail molds 32. The plurality of input ports 58 may be attached to a plurality of resin hoses 68 which are in fluid communication with a resin reservoir 70 filled with resin 62. The plurality of output ports 60 may be connected to a flexible tube 72 in fluid communication with a vacuum pump 74. When the second vacuum bag 56 is sealed, the vacuum pump 74 may be activated to create a vacuum within the second vacuum bag 56. At this point, resin 62 may flow from the resin reservoir 70 to a manifold 76 which distributes resin 62 to the plurality of input ports 58. The resin input ports 58 are aligned to the resin inputs 42 formed in the detail molds 32. The resin 62 then proceeds through the resin inputs 42 of the detail molds 32 and flows through the resin channels 46 (see FIG. 8) toward the fibrous material 24 wrapped on the interface surface 34 and the detail surface 36 of the detail molds 32. When the resin 62 reaches the distal end 78 of the resin channels 46, as shown in FIG. 8, a back pressure is created to thereby squeeze out the resin 62 with a uniform flow front 80a, b shown in FIG. 8 by the dashed lines. Flow fronts 80a and 80b shows the uniform development of the flow front 80 as the resin 62 flows under the detail mold 32. The resin flow front 80a, b proceeds toward the fibrous material 24 laid on the interface surface 34 of the detail mold 32 and flows upward into the fibrous material 24 laid on the detail surface 36. The vacuum draws the resin 62 through the resin output ports 60 and into a resin reservoir 82. Prior to the flow of resin 62 through the fibrous material 24, the fibrous material 24 may be heated to an operating temperature based on the selection of the fibrous material 24 and the resin combination. It is also contemplated that a resin/fibrous material combination may be matched such that the resin 62 is flowed through the fibrous material 24 and then raised to a cure temperature to co-cure the part with the detail.

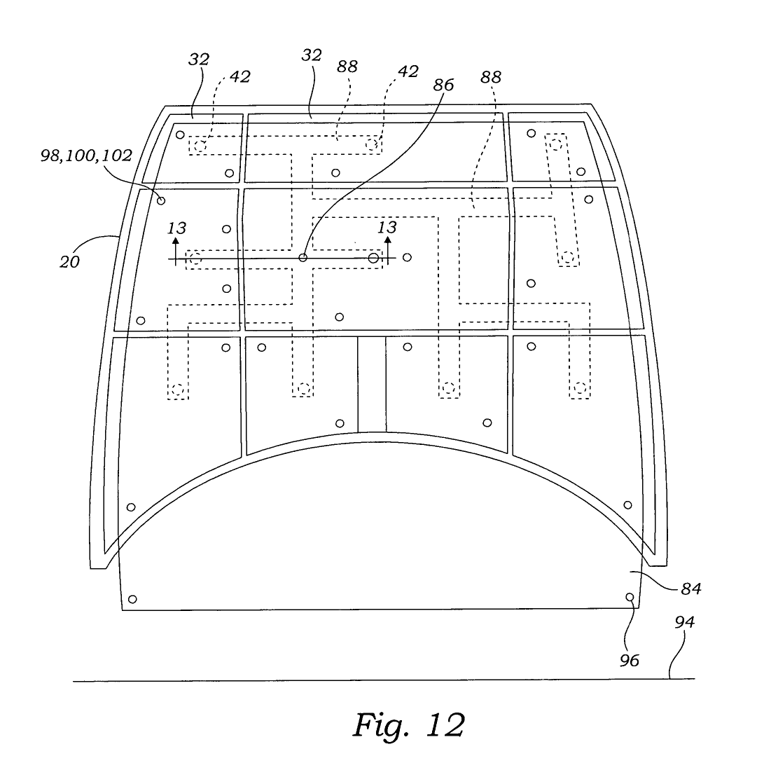

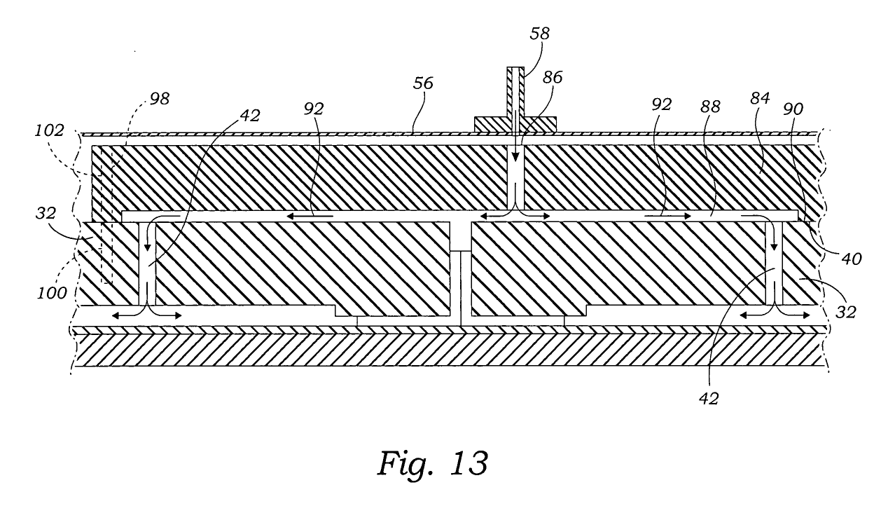

In the alternative, as shown in FIG. 12, a manifold 84 having a single resin input 86 and a plurality of resin channels 88 may be placed on top of the plurality of assembled detail molds 32 wherein the resin channels 88 of the manifold 84 provides a resin flow path from the resin input 86 of the manifold 84 to the resin input 42 of the detail molds 32. In particular, as shown in FIG. 13, a bottom surface 90 of the manifold 84 may mate with the top surfaces 40 of the detail molds 32 so as to form a resin flow path 92 through the resin channels 88 of the manifold 84. The resin reservoir 70 may be in fluid communication with the resin input port 58 of the second vacuum bag 56 which is alignable to the resin input 86 of the manifold 84. When vacuum is applied to the second vacuum bag 56, resin 62 flows from the resin reservoir 70 through the resin input port 58 of the second vacuum bag 56 and through the resin input 86 of the manifold 84 and distributes the resin 62 to the resin inputs 42 of the detail molds 32 via the resin channels 88 of the manifold 84. The manifold 84 may be fabricated from a formable material such as glass or a rigid material such as aluminum based on the contour of the top surfaces 40 of the detail molds 32.

The manifold 84 may also serve the purpose of locating the detail molds 32 with respect to the tool mold 20. In particular, if the detail molds 32 are merely laid on top of the molding surface 22 of the tool mold 20, the location of the detail molds 32 may be considerably varied based on a contention that the detail molds 32 are designed to have some space therebetween when they 32 are disposed on the tool mold 20 in the jig saw configuration. To more accurately locate the detail molds 32 with respect to the tool mold 20, as shown in FIG. 12, the manifold 84 may be fixed to a datum 94 via pins 102. Pin apertures 98 (see FIGS. 12 and 13) may also be formed in the manifold 84 above each of the detail molds 32 and a pin hole 100 (see FIGS. 12 and 13) aligned to the pin aperture 98 may be formed in each of the detail molds 32. The pin 102 (see FIGS. 12 and 13) may be inserted into each of the pin apertures 98 of the manifold 84 and respective pin holes 100 of the detail molds 32 to locate the detail molds 32 with respect to the datum 94. In this manner, the detail molds 32 are located with respect to the datum 94 via the manifold 84 and not merely placed on top of the molding surface 22 and positioned by an interference fit therebetween.

In another aspect of the method disclosed herein, the method of fabricating a part having a detail enables a business to divide the labor of fabricating the part having the detail. The method permits a plurality of employees to work on respective detail molds 32 and tool mold 20. In particular, as discussed above, there may be a plurality of detail molds 32 and a tool mold 20 which may be wrapped and laid with fibrous material 24 and assembled together, flowed with resin 62, and co-cured to produce a part having a detail. Advantageously, each of the detail molds 32 may be worked on by different employees, and also, the tool mold 20 may be worked on by a different employee than those working on the detail molds 32. As such, a plurality of employees may work on a single part having details thereby dividing the labor to fabricate the part having the detail. For example, if the part having the detail requires four detail molds 32 and one tool mold 20, and each detail mold 32 requires one man hour to finish and the tool mold 20 requires two man hours, then the total number of man hours required to fabricate the part would be six man hours. Accordingly, a business having one employee working on the detail molds 32 and the tool mold 20 of the part may fabricate one part every six hours. Advantageously, with the method discussed above in fabricating the part having the detail, the business may have three employees working on the detail molds 32 and the tool mold 20. Two employees may each work on two of the detail molds 32 thereby completing the work required on four detail molds 32 in two hours. The third employee may work on the tool mold 20 and complete work on the tool mold 20 in two hours. Accordingly, the business may fabricate one part having the details every two hours. By this simple illustration, the output of the business may be increased threefold.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of dividing resin flow through fibrous material into manageable regions, the fibrous material having a configuration of a part having integral structural details, the method comprising the steps of:
laying fibrous material on a tool mold;
wrapping fibrous material on a plurality of detail molds;
arranging the detail molds on the tool mold such that the fibrous materials have a configuration of the part having the detail; and
flowing resin independently through the fibrous material wrapped on each detail mold such that a resin flow front through fibrous material of one of the detail molds is not affected by a resin flow front through fibrous material of the other molds.

2. The method of claim 1 further comprising the step of forming resin channels on a bottom surface of the detail molds in a star burst configuration.
Broaden claim to include other/all channel configurations (eg. fan, cross, etc.)?

3. The method of claim 1 further comprising the steps of:
providing a manifold plate having an input and a plurality of channels alignable to resin inputs of the detail molds; and
aligning the channels of the manifold to the resin inputs of the detail molds for forming a resin conduit through which resin is flowed from the manifold and directed to the resin inputs of each detail molds.

4. The method of claim 3 wherein the arranging step comprises the steps of:
forming pin holes in the detail molds;
forming pin apertures in the manifold;
aligning the pin apertures and the pin holes; and
inserting pins into aligned pin apertures and pin holes for positioning the detail molds with respect to each other.

5. The method of claim 4 further comprising the step of positioning the manifold with respect to the tool mold for positioning the detail molds with respect to the tool mold.

6. A method of distributing resin into fibrous material, the fibrous material having a configuration of a part having a detail, the method comprising the steps of:
attaching fibrous material to a plurality of molds;
arranging the molds such that the fibrous materials have a configuration of the part having the detail;
providing a manifold plate having an input and a plurality of channels alignable to resin inputs of the molds; and
aligning the channels of the manifold to the resin inputs of the molds for forming a resin conduit through which resin is flowed from the manifold and directed to the resin inputs of the molds.

7. The method of claim 6 wherein each mold has a resin input and the channels of the manifold are alignable to the resin inputs.

8. A method of increasing production of a part having a detail, the method comprising the steps of:
instructing a first person to wrap fibrous material about a plurality of detail molds;
instructing a second person to lay fibrous material on a tool mold;
arranging the detail molds on the tool mold such that the fibrous materials have a configuration of the part having the detail; and
flowing resin through the fibrous material.

9. The method of claim 8 wherein the resin is flowed independently through the fibrous material wrapped about each detail mold such that a resin flow front through fibrous material of one of the detail molds is not affected by a resin flow front through fibrous material of the other detail molds.
